(19) United States
(12) Patent Application Publication
(10) Pub. No.: US 2017/0193418 A1
(43) Pub. Date: Jul. 6, 2017

(54) PHYSICALLY FORWARDING ITEMS

(71) Applicant: Wal-Mart Stores, Inc., Bentonville, AR (US)

(72) Inventors: Donald R. High, Noel, MO (US); Karl Kay, Gentry, AR (US); Michael D. Atchley, Springdale, AR (US)

(21) Appl. No.: 15/397,881

(22) Filed: Jan. 4, 2017

Related U.S. Application Data
(60) Provisional application No. 62/275,147, filed on Jan. 5, 2016.

(51) Int. Cl. G06Q 10/06; B65G 61/00; B25J 9/00; G06Q 10/08

(52) U.S. Cl. CPC G06Q 10/06315; G06Q 10/083; B65G 61/00; B25J 9/0093

(57) ABSTRACT

Upon receiving a standard unit of items at a distribution center these teachings provide for automatically determining whether to retain that standard unit of items as staple stock at the district center or to forward that unit to a retail shopping facility without first retaining that unit as staple stock at the distribution center. Such a determination can include determining whether there is a present need at the retail shopping facility for at least the standard unit of items. By one approach, these teachings will support forwarding the standard unit of items to a particular retail shopping facility that may have a present need for some of the items but less than the complete standard unit of items.

### CROSS-REFERENCE TO RELATED APPLICATION

This application claims the benefit of U.S. Provisional Application No. 62/275,147, filed Jan. 5, 2016, and is incorporated herein by reference in its entirety.

### TECHNICAL FIELD

These teachings relate generally to the physical movement of items including items that are not presently directly associated with a particular recipient.

### BACKGROUND

A modern physical shopping facility typically has on hand a vast number of different items that are offered for retail purchase. In many cases that facility also has multiple numbers of each item in order to accommodate likely or possible demand. Generally speaking, however, that inventory must be replenished from time to time to maintain an adequate on-hand stock.

In some cases that replenishment stock comes directly from a manufacturer. In many other cases, that replenishment stock comes to the retail shopping facility via a distribution center, warehouse, or the like where the stock was previously received and stored as staple stock pending such a need.

Holding replenishment staple stock in storage at an intermediary location represents a considerable cost.

### BRIEF DESCRIPTION OF THE DRAWINGS

The above needs are at least partially met through provision of the physically forwarding items described in the following detailed description, particularly when studied in conjunction with the drawings, wherein:

FIG. 1 comprises a flow diagram as configured in accordance with various embodiments of these teachings;

FIG. 2 comprises a schematic block diagram as configured in accordance with various embodiments of these teachings;

FIG. 3 comprises a perspective view as configured in accordance with various embodiments of these teachings; and

FIG. 4 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field set forth above except where different specific meanings have otherwise been set forth herein.

### DETAILED DESCRIPTION

Generally speaking, pursuant to these various embodiments, upon receiving a standard unit of items at a distribution center these teachings provide for automatically determining whether to retain that standard unit of items as staple stock at the district center or to forward that unit to a retail shopping facility without first retaining that unit as staple stock at the distribution center. Such a determination can include determining whether there is a present need at the retail shopping facility for at least the standard unit of items. By one approach, these teachings will support forwarding the standard unit of items to a particular retail shopping facility that may have a present need for some of the items but less than the complete standard unit of items.

So configured, stock can more regularly arrive at the distribution center and then be immediately routed to a recipient retail shopping facility without first entering the distribution center as staple stock that is later provided to a recipient retail shopping facility in due course at some time of replenishment need. By applying these teachings in a relatively general manner across a wide variety of items, a distribution center can serve less and less as an intermediary warehouse.

By one approach the aforementioned standard unit of the items comprises a unitized plurality of standard sub-units that each contain a like number of the items. In such a case, if desired, these teachings will also provide for automatically determining whether to forward at least some of the standard sub-units of items to a plurality of retail shopping facilities without first retaining the aforementioned standard unit of items as staple stock at the distribution center. In such a case, the unitized plurality of standard sub-units may be broken down at the distribution center such that some of the sub-units of items are forwarded immediately to retail shopping facilities while one or more of the standard sub-units of items are retained as staple stock distribution center.

So configured, it is possible that a particular retail shopping facility will receive more stock than is presently required for anticipated needs. The applicants have determined, however, that in many cases this temporary overstocking of one or more retail shopping facilities can be a better trade-off overall than providing, maintaining, staffing, and operating a distribution center or regional warehouse to hold such items as staple stock.

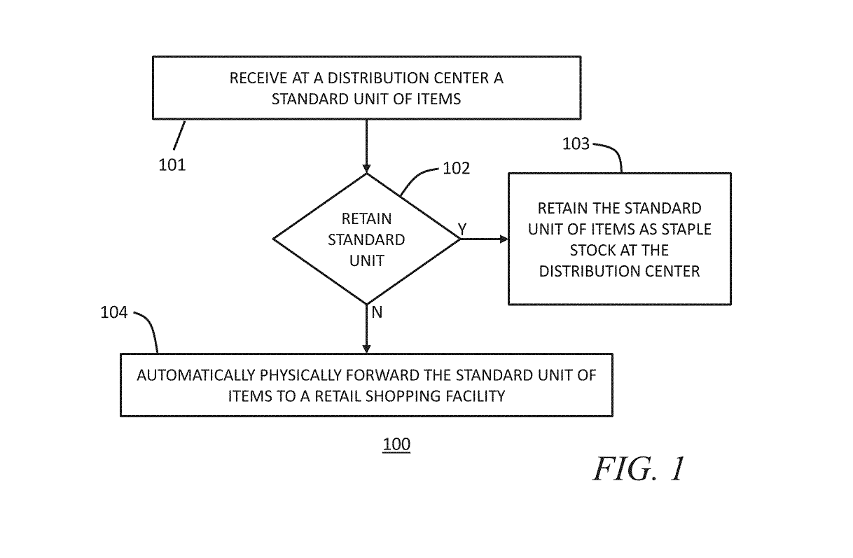

These and other benefits may become clearer upon making a thorough review and study of the following detailed description. Referring now to the drawings, and in particular to FIG. 1, an illustrative process 100 that is compatible with many of these teachings will now be presented.

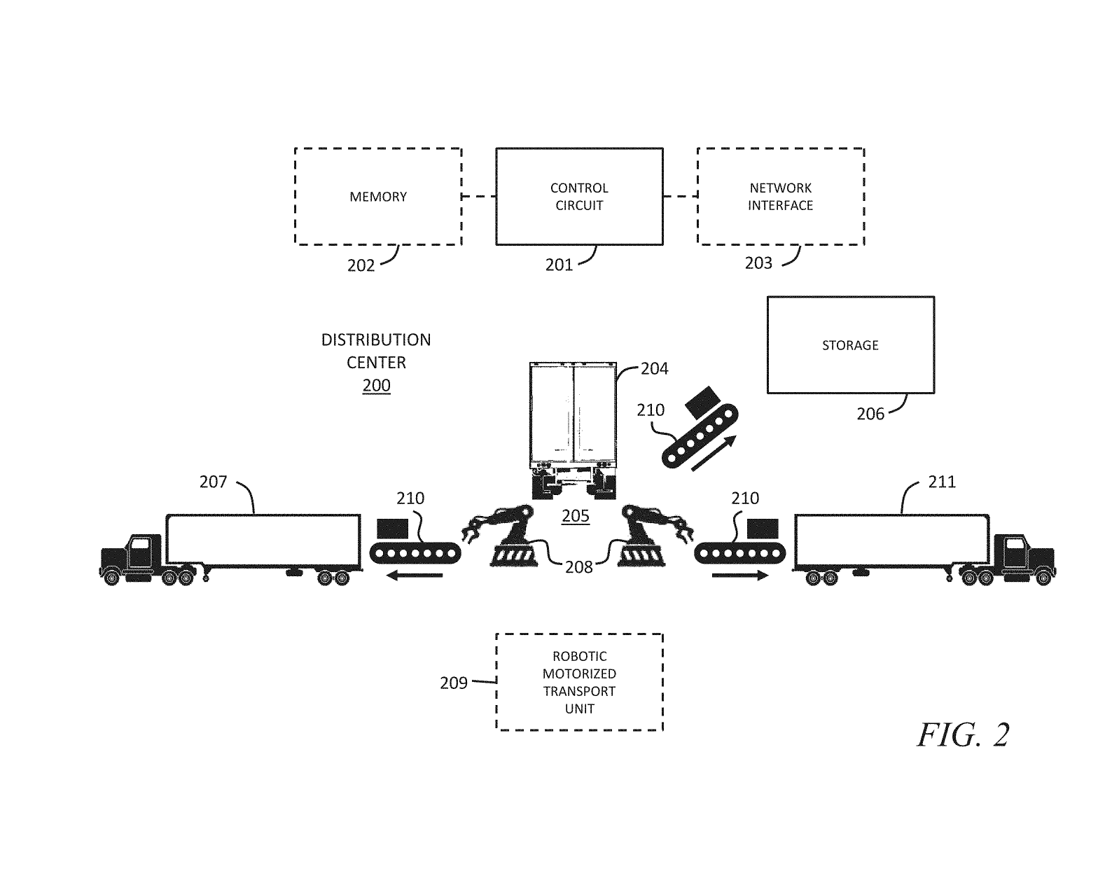

By one approach, at least some of the actions in this process 100 are facilitated or carried out by a control circuit. FIG. 2 presents an illustrative application setting in these regards.

In this example a distribution center 200 includes such a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one optional approach the control circuit 201 operably couples to an optional memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

This memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 201 may also operably couple to an optional network interface 203. So configured the control circuit 201 can communicate with other elements (both within the apparatus 200 and external thereto) via the network interface 203. Network interfaces, including both wireless and non-wireless platforms, are well understood in the art and require no particular elaboration here.

With continued reference to both FIGS. 1 and 2, at block 101 the process provides for receiving at the distribution center 200 at least one standard unit of items. In this example, the standard units of items are offloaded from a delivery vehicle 204 in an unloading area 205 such as a dock. Various delivery vehicles are known in the art as are unloading-area designs and configurations. As the present teachings are not overly sensitive to any particular choices in these regards, further elaboration is not provided here in relation to the details of these components.

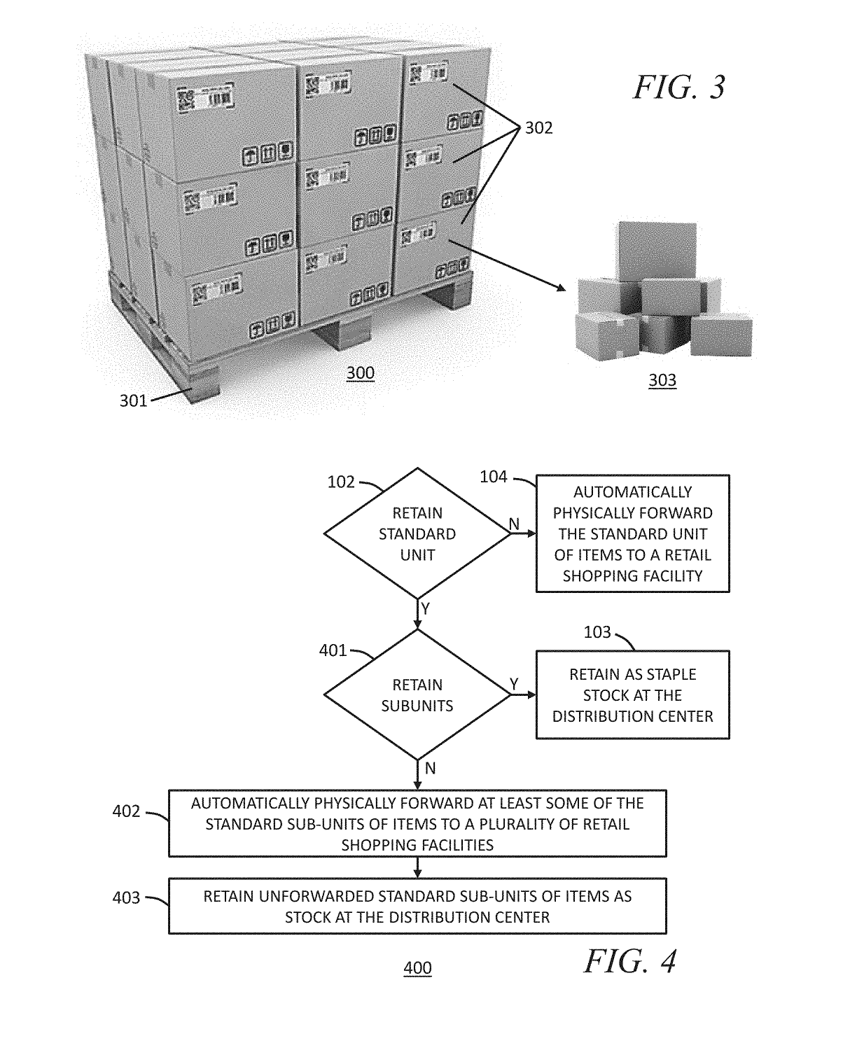

With momentary reference to FIG. 3, the standard unit 300 of items comprises a unitized plurality of standard sub-units 302 that each contain a like number of the items 303. In this particular illustrative example the plurality of standard sub-units 302 each comprises a case (such as a cardboard case or box having a standard size) of the items 303 that are “unitized” by being co-placed and affixed atop a pallet 301 (using, for example, tarps, shrink wrap, straps, and so forth). So configured, the palletized plurality of the items 303 has a generally standardized form factor as regards its Cartesian dimensions and the availability of slots to receive the forks of a fork lift vehicle.

Although such a standard unit of items 300 comprises a “standard,” these teachings will nevertheless accommodate a plurality of different standards in these regards. For example, one standard can specify a pallet 301 having nine cases 302 stacked thereon while another standard can specify a pallet 301 having twenty-seven such cases 302 stacked thereon. It is also possible that the case 302 can comprise any of a variety of standardized sizes (where, for example, there are nine differently-sized cases that are employed by a particular enterprise for these purposes).

In a traditional prior art application setting the unloaded standard units 300 would be transported to a storage area 206 at the distribution center 200. These standard units 300 might be stored in a palletized form or might be broken down and stored as individual cases 302. In some cases, some of the cases 302 might be opened and the individual items 303 stored in a singulated manner. In all of these examples the items are stored as staple stock that is then available to transport to retail shopping facilities on an as-needed basis. The duration of storage at the distribution center for any particular item 303 will vary with supply and demand. So configured, a prior art distribution center carries out three primary functions for each item; receiving the item, storing the item pending a need, and retrieving the item from storage and forwarding that item to the facility having need of the item.

Pursuant to the present process 100, however, storing the item may be avoided for some, most, or even all received items.

With continuing reference to FIGS. 1-3, at block 102 the control circuit 201 automatically determines whether to retain a standard unit 300 of items as staple stock at the distribution center 200 (i.e., whether to store the standard unit 300 at the distribution center) or whether to forward the standard unit 300 of items 303 to a retail shopping facility without first retaining the standard unit 300 of items 303 as staple stock at the distribution center 200. (As used herein, it will be understand that storing an item 303 as staple stock means to hold the item 303 in a storage area 206 without any present intent or likelihood of removing that item from storage to transport to a particular remote recipient. The actual duration of the storage can vary greatly and can be relatively brief or of a very long span of time.)

The foregoing determination can comprise, for example, determining whether there is a present need at the retail shopping facility for at least the standard unit 300 of items 303 (that is, that there is a need at that retail shopping facility for at least that many of this particular item 303). When such a need exists the control circuit 201 can provide for automatically physically forwarding (at block 104) the standard unit 300 of items 303 to the retail shopping facility. In particular, the foregoing comprises moving the standard unit 300 of items 303 from the unloading area 205 to another delivery vehicle 207 where the standard unit 300 of items 303 is loaded onto that delivery vehicle 207 for transport to the retail shopping facility. (These teachings will accommodate a variety of approaches with respect to moving that material to the outbound delivery vehicle 207. One of more robotic arms 208 and/or one or more robotic motorized transport units 209 (such as unmanned forklifts) can serve to lift and/or transport the standard units 300 of items 303 as can one or more conveyor systems 210.)

Accordingly, although this standard unit 300 of items 303 may pause from time to time during the unloading and loading process, the standard unit 300 of items 303 is not stored at the distribution center 200 as “staple stock.” Instead, the storage activity simply does not occur for this standard unit 300 of items 303.

It is possible that the retail shopping facility does not presently need as many of the items 303 as are contained in the standard unit 300. Pursuant to this process 100, however, the control circuit 201 can nevertheless determine to physically forward a full standard unit 300 of items 303 to a retail shopping facility that has a present need for some such items 303 (albeit where that need is for less than the complete standard unit 300 of items 303). In this case, the receiving retail shopping facility will receive more of the items 303 than are presently required. The applicants have determined, however, that in many cases it can be economically more sensible to store (as staple stock) the presently-unneeded items 303 at the retail shopping facility than at the distribution center 200.

By one approach the control circuit 201 can be configured to ensure that all received standard units 300 of items 303 are physically forwarded upon receiving those standard units 300 of items 303, first by sending standard units 300 of items 303 to retail shopping facilities that have a present need for a complete standard unit 300 of the items 303 and secondly by sending standard units 300 of items 303 to retail shopping facilities having a present need for some, albeit not all, of the items 303 in a standard unit 300. If desired, this process 100 can be configured (see block 103) to retain one or more of the standard units 300 of items 303 as staple stock at the distribution center 200 when there are simply too many standard units 300 of items 303 to permit full usage of the foregoing forwarding strategy.

To facilitate such an approach the control circuit 201 can make the foregoing determinations regarding whether to forward a standard unit 300 of items 303 to a retail shopping facility without first retaining the standard unit 300 of items 303 as staple stock at the distribution center 200 by automatically making that determination as a function, at least in part, of a weighted preference for storing presently-unneeded items at retail shopping facilities rather than at the distribution center 200. That weighting can vary, if desired, from one item 303 to another to accommodate different concerns (such as storage space requirements, anticipated shelf life, a rate at which a particular item 303 tends to sell, and so forth). The weighting can also vary with respect to operating parameters such as available storage space at the retail shopping facilities, available personnel at the retail shopping facilities, weather and/or traffic forecasts, and so forth.

The foregoing determination can also take into account, if desired, whether some on-hand previously-stored staple stock at the distribution center 200 should be sent to a retail shopping facility instead of forwarding a presently-received standard unit 300 of items 303. Such a decision can be appropriate when, for example, the item 303 has a limited shelf life and it makes better logistical sense to forward the item 303 from staple stock and to replenish that staple stock using the presently-received items 303.

Pursuant to the foregoing process 100 the store-or-forward decisions are made on a standard unit-by-standard unit basis. These teachings will accommodate finer granularity in these regards if desired, however. FIG. 4 provides an illustrative example in such regards.

In this example, upon determining to retain a standard unit 300 of items 303 at decision block 102, the process 400 then determines at block 401 whether to physically forward at least some of the standard sub-units 302 of items 303 to a plurality of retail shopping facilities without first retaining the standard unit 300 of items 303 as staple stock at the distribution center 200. For example, if no retail shopping facility presently needs a full standard unit 300 of items 303 but two retail shopping facilities each presently need half a standard unit 300 of items 303, the control circuit 201 can determine to break the standard unit 300 and, at block 402, automatically physically forward half of the standard sub-units 302 to a first retail shopping facility via a first delivery vehicle 207 and the remaining half of the standard sub-units 302 to a second retail shopping facility via a second delivery vehicle 211.

When, for whatever reason, there are some remaining standard sub-units 302 of the items 303, at block 403 those unforwarded standard sub-units 302 of items 303 can be retained as staple stock at the distribution center 403.

It would be possible, if desired, to break open individual standard sub-units 302 and carry out the foregoing forwarding/storing decisions on an item-by-item basis. The larger and/or heavier the individual item, the more useful such an approach might be.

So configured, these teachings can help to greatly reduce or even to nearly eliminate the intermediary storage of items being shipped to a retail shopping facility. Such a result can yield considerable cost savings that benefit all parties concerned.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method comprising:
receiving at a distribution center a standard unit of items, the standard unit comprised of unitized plurality of standard sub-units that each contain a like number of the items;
automatically determining whether to retain the standard unit of items as staple stock at the distribution center or whether to forward the standard unit of items to a retail shopping facility without first retaining the standard unit of items as staple stock at the distribution center; and
automatically physically forwarding the standard unit of items to the retail shopping facility when determining to forward the standard unit of items to the retail shopping facility.

2. The method of claim 1 wherein the standard unit comprises a palletized plurality of the items and the standard sub-units each comprise a case of a plurality of the items.

3. The method of claim 1 wherein automatically physically forwarding the standard unit of items to the retail shopping facility comprises automatically manipulating a robotic motorized transport unit to direct the standard unit of items to a delivery vehicle.

4. The method of claim 1 wherein automatically determining whether to retain the standard unit of items as staple stock at the distribution center or whether to forward the standard unit of items to a retail shopping facility comprises, at least in part, determining whether there is a present need at the retail shopping facility for at least the standard unit of items.

5. The method of claim 1 wherein automatically determining whether to retain the standard unit of items as staple stock at the distribution center or whether to forward the standard unit of items to a retail shopping facility comprises, at least in part, determining whether there is a present need at the retail shopping facility for some of the items but less than the standard unit of items and responsively forwarding the standard unit of items to the retail shopping facility notwithstanding that the retail shopping facility does not presently need that many of the items.

6. The method of claim 1 further comprising:
automatically determining whether to retain the standard unit of items as staple stock at the distribution center or whether to forward at least some of the standard sub-units of items to a plurality of retail shopping facilities without first retaining the standard unit of items as staple stock at the distribution center;
automatically physically forwarding at least some of the standard sub-units of items to the plurality of retail shopping facilities when determining to forward at least some of the standard sub-units of items to the plurality of retail shopping facilities.

7. The method of claim 6 wherein automatically physically forwarding at least some of the standard sub-units of items to the plurality of retail shopping facilities comprises automatically using a robotic arm to direct the standard sub-units of items to at least one corresponding delivery vehicle.

8. The method of claim 1 wherein receiving at the distribution center the standard unit of items comprises receiving the standard unit of items as offloaded from a delivery vehicle.

9. The method of claim 1 wherein automatically determining whether to retain the standard unit of items as staple stock at the distribution center or whether to forward the standard unit of items to a retail shopping facility without first retaining the standard unit of items as staple stock at the distribution center comprises automatically making the determination as a function of a weighted preference for storing presently-unneeded items at retail shopping facilities rather than at a distribution center.

10. The method of claim 1 wherein automatically determining whether to retain the standard unit of items as staple stock at the distribution center or whether to forward the standard unit of items to a retail shopping facility without first retaining the standard unit of items as staple stock at the distribution center comprises automatically making the determination as a function of whether some previously-stored items at the distribution center should be sent instead to the retail shopping facility.

11. An apparatus comprising:
a distribution center configured to receive a standard unit of items, the standard unit comprised of unitized plurality of standard sub-units that each contain a like number of the items;
a control circuit configured to:
automatically determine whether to retain the standard unit of items as staple stock at the distribution center or whether to forward the standard unit of items to a retail shopping facility without first retaining the standard unit of items as staple stock at the distribution center;
automatically physically forward the standard unit of items to the retail shopping facility when determining to forward the standard unit of items to the retail shopping facility.

12. The apparatus of claim 11 wherein the standard unit comprises a palletized plurality of the items and the standard sub-units each comprise a case of a plurality of the items.

13. The apparatus of claim 11 wherein the control circuit is configured to automatically physically forward the standard unit of items to the retail shopping facility by automatically manipulating a robotic motorized transport unit to direct the standard unit of items to a delivery vehicle.

14. The apparatus of claim 11 wherein the control circuit is configured to automatically determining whether to retain the standard unit of items as staple stock at the distribution center or whether to forward the standard unit of items to a retail shopping facility by, at least in part, determining whether there is a present need at the retail shopping facility for at least the standard unit of items.

15. The apparatus of claim 11 wherein the control circuit is configured to automatically determine whether to retain the standard unit of items as staple stock at the distribution center or whether to forward the standard unit of items to a retail shopping facility by, at least in part, determining whether there is a present need at the retail shopping facility for some of the items but less than the standard unit of items and responsively forwarding the standard unit of items to the retail shopping facility notwithstanding that the retail shopping facility does not presently need that many of the items.

16. The apparatus of claim 11 wherein the control circuit is further configured to:
automatically determine whether to retain the standard unit of items as staple stock at the distribution center or whether to forward at least some of the standard sub-units of items to a plurality of retail shopping facilities without first retaining the standard unit of items as staple stock at the distribution center;
automatically physically forward at least some of the standard sub-units of items to the plurality of retail shopping facilities when determining to forward at least some of the standard sub-units of items to the plurality of retail shopping facilities.

17. The apparatus of claim 16 wherein the control circuit is configured to automatically physically forward at least some of the standard sub-units of items to the plurality of retail shopping facilities by automatically using a robotic arm to direct the standard sub-units of items to at least one corresponding delivery vehicle.

18. The apparatus of claim 11 wherein the distribution center is configured to receive at the standard unit of items by receiving the standard unit of items as offloaded from a delivery vehicle.

19. The apparatus of claim 11 wherein the control circuit is configured to automatically determine whether to retain the standard unit of items as staple stock at the distribution center or whether to forward the standard unit of items to a retail shopping facility without first retaining the standard unit of items as staple stock at the distribution center by automatically making the determination as a function of a weighted preference for storing presently-unneeded items at retail shopping facilities rather than at a distribution center.

20. The apparatus of claim 11 wherein the control circuit is configured to automatically determine whether to retain the standard unit of items as staple stock at the distribution center or whether to forward the standard unit of items to a retail shopping facility without first retaining the standard unit of items as staple stock at the distribution center by automatically making the determination as a function of whether some previously-stored items at the distribution center should be sent instead to the retail shopping facility.
